(19) United States
(12) Patent Application Publication
(10) Pub. No.: US 2015/0098869 A1
(43) Pub. Date: Apr. 9, 2015

(54) Commercialization of carbon dioxide from coal fired furnace emissions

(71) Applicant: Edward Milton McWhorter, Citrus Heights, CA (US)

(72) Inventor: Edward Milton McWhorter, Citrus Heights, CA (US)

(21) Appl. No.: 13/998,143

(22) Filed: Oct. 7, 2013

(51) Int. Cl. B01J 19/08

(52) U.S. Cl. CPC B01J 19/088
USPC 422/148

(57) ABSTRACT

A procedure for producing unstable aldehydes from coal combustion emission by inserting protons (H⁺) within the double bond interstice structure of heated CO₂ carrier gas to form a univalent aldehyde (CO₂H⁺). The univalent aldehydes are actinically radiated by a massless negative charge that is ejected from a filament rail magnetic induction circuit at 1 sec. intervals during periods of high emf shock loading. The negative charge actinic radiation passes through a ceramic cylinder wall of an alignment chamber and is attracted to the electrophilic proton (H⁺) enmeshed in the CO₂ double bond interstice structure weakening the structure. The weakened structure allows the enmeshed proton (H+) to be subsequently removed in a proceeding process in an anodal stabilization chamber for the production of carbon chains.

### CROSS REFERENCES

Ref. 1 U.S. Pat. No. 8,378,768 B2 Filed Nov. 26, 2010 “Radial and Linear Magnetic Axial Alignment Chamber”

### Claim of Priority

The present application claims priority from U.S. application Ser. No. 12/462,654 filed Aug. 7, 2009 Publication US-2009-0324456-A1 Publication date Dec. 31, 2009 the content of which is hereby amended and incorporated by reference into this application.

### BACKGROUND OF THE INVENTION

The invention is a filament rail magnetic induction circuit for use in chemical polymerization of carbon dioxide molecules to form carbon chains. The term “rail” is used to indicate the use of an electrical bus-bar circuit required to carry intense electrical pulse discharges hereinafter referred to as “emf shock loading”. The polymerization process begins by cleaving the hydrogen to oxygen bonds (H—O) of water molecules at 1 sec intervals during the hydrolyzation of sodium to produce negative electron charges (e⁻) and positive charged protons (H⁺) as shown Eq. 1.

Na+H—OH→NaOH+H⁺+e⁻ Eq. 1

If Eq. 1 is allowed to proceed through a series of intermediate ionization equilibrium reactions the fully reacted system will settle to the lowest potential energy level and no useful energy can be extracted from the process. In order to prevent the reaction of Eq. 1 from proceeding to equilibrium the reactants are passed through an ionic capacitor which electrostatically remove negative ion charges.

The NaOH component of Eq. 1 is removed in intermediate secondary reactions in the formation of sodium carbonate (Na₂CO₃nH₂O). The sodium carbonate (N₂CO₃) is inert and has no further effect within the reacting system and is removed as a precipitant.

The sodium hydrolyzation reactions of Eq. 1 occur within a heated CO₂ carrier gas flowing through the hydrolyzation chamber at 6000 lbs/hr (3 tons CO₂/hr). The injection rate of sodium is 1 lb/hr or 126 mg/sec. The protons (H⁺) released in the hydrolyzation reaction of Eq. 1 are distributed within the thermally expanded interstices of the heated CO₂ molecules of the carrier gas. The diffuse stream of the carrier gas is passed through an expansion nozzle that cool the gaseous flow locking the positive charged protons within the heated CO₂ carrier gas interstice passing into the ceramic chamber of the filament rail magnetic induction circuit. The negative electrons of Eq. 1 pass through a dielectric capacitor circuit into an inlet electrical collector ring and pass through a plurality of wire segment filaments positioned on the outer surface of the ceramic cylinder wall of the chamber of the filament rail magnetic induction circuit. The positive charged protons (H⁺) of Eq. 1 are enmeshed within the fluid circuit flowing in the ceramic circuit and the negative electron (e⁻) of Eq. 1 are passing through the wire segment filaments positioned on the outer surface of the ceramic chamber. The positive proton (H⁺) and the negative electrons (e⁻) are separated on s opposite sides of the ceramic chamber of the filament rail magnetic induction circuit are held in polar juxtaposition position for reaction in the next proceeding process.

Electron (e⁻) plenary fields are formed by the wire segment filaments during intervals of low current flow. But at intervals of higher current flow the electrons fields begin to compact and become oblately compressed as they approach the more severe curvature of the filaments. At emf shock loading intervals the compression of the fields become critically oblate and cannot follow the spin of the electron and portions of the oblate field are ejected. At emf shock loading conditions the negative charged oblate fields are ejected through the ceramic cylinder wall of the alignment chamber and react with the electrophilic univalent aldehyde (CO₂H⁺) loosening interstitial structure of CO₂ molecule holding the proton (H⁺). The proton is released from univalent aldehyde in an anodal stabilization chamber during the next proceeding process.

### SUMMARY OF THE INVENTION

The invention is a procedure for the intermediate preparations of univalent aldehydes to be used in the subsequent synthesis of carbon chain polymers from coal combustion emissions.

### BRIEF DESCRIPTION OF THE DRAWINGS

Two drawings are presented. The proprietary novel features of the invention are presented in FIG. 1 as elements 1 through 12.

FIG. 1 is a side view of the filament rail magnetic induction alignment chamber shown in section.

FIG. 2 is a side view of the actinic electrode.

### DETAILED DESCRIPTION OF THE INVENTION

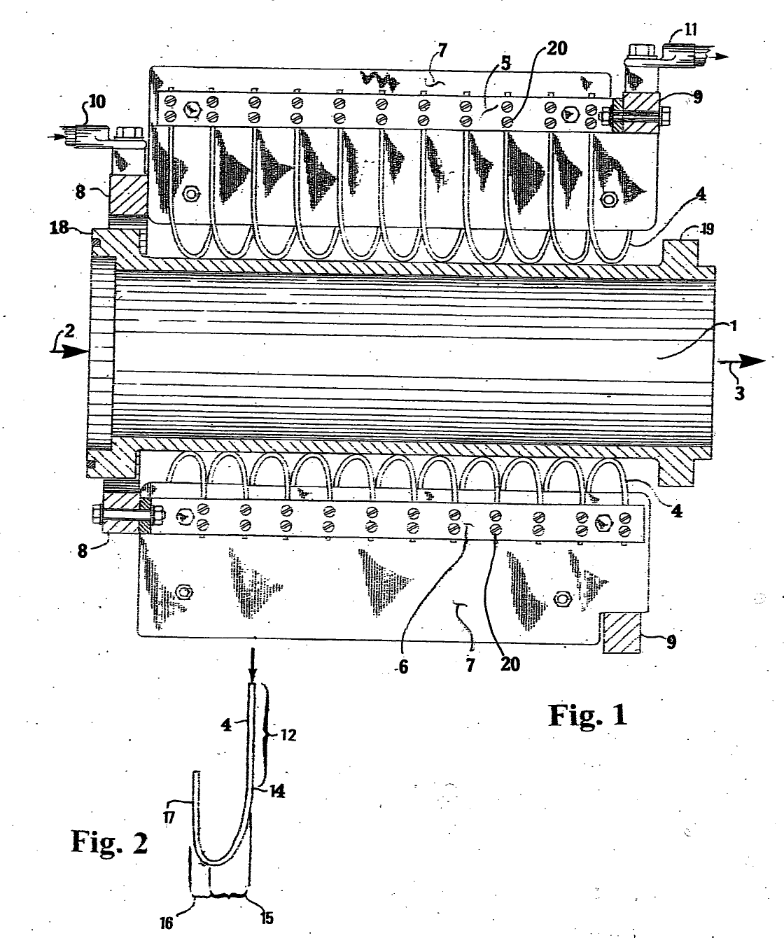

An alignment chamber comprising a filament rail magnetic induction circuit positioned over a ceramic cylinder 1 having an inlet flange 18 and an exit flange 19 as shown in FIG. 1. The alignment chamber uses in its respective electrical and fluidic circuits the electrons (e⁻) and protons (H⁺) which have been separated from water molecules by hydrolyzation of finite quantities of sodium, or other alkaline metals, within a heated CO₂ carrier gas 2 flowing through ceramic chamber 1. Hydrolyzation occurs at (1 sec) intervals producing coulombic surge of electrons (e⁻) and protons (H⁺) in Eq. 1. The protons (H⁺) become lodged within the interstice of the heated CO₂ carrier gas molecules, which on expansion through a nozzle are cooled shrinking the gaseous diffusion within ceramic cylinder 1 causing the CO₂ interstice volume to decrease tightening the of hold of the protons (H⁺) which form an ionic univalent aldehyde (CO₂H⁺). The univalent aldehyde (CO₂H⁺) is the process product that is claimed. The electrons (e⁻) severed from the water molecules pass through inlet shock loading cable 10 and pass into inlet electrical collector ring 8 and pass into a plurality of bus-bars 5 that are longitudinally aligned with the axis of ceramic cylinder 1 at evenly spaced radial intervals about the outer surface of ceramic cylinder 1. A plurality of outlet bus-bars 6 are aligned and evenly spaced between inlet bus-bars 5 and connected to outlet electrical collector ring 9. A plurality of U-shape wire segment filaments 4 are electricallly connected in parallel circuits between the inlet bus-bar 5 and the outlet bus-bar 6 as evenly spaced intervals above the outer surface of ceramic cylinder 1. Insulator panels 7 are positioned within the U-shape wire segment filaments to prevent electrical shorting between the inlet bus-bar 5 and the outlet bus-bar 6.

Turning now to FIG. 2 which is a side-view of wire segment filament 4. The wire segment filament 4 of the filament rail magnetic induction circuit radiates two kinds of electron negative charge fields, spherical plenary fields and oblate divisional fields. When electrons traveling in the wire segment filament approach a point of greater curvature they begin to lose momentum and the decelerate at the higher resistance of the sharper turning curve and their negative fields become more closely compact and begin to compress. The repulsing like-on-like negative plenary fields become compresses and distorted into oblate divisional fields which cannot follow the spin of the parent electron and become divided from the parent electron and are ejected through the wall of the ceramic cylinder of the alignment chamber. Electrons travel in filament 4 at the highest speed in the straight inlet portion 12 of filament 4. Electron compaction in filament 4 begins at the inlet inflection point 14 and continues through compaction section 15. Compaction of the electron fields and the electrons ends at point 16 and accelerates to full speed again in section 17.

### NUMBERED ELEMENTS OF THE INVENTION

### Element

1. ceramic cylinder
2. carrier gas
3. product
4. wire segment filaments (shown 22 places)
5. inlet bus-bar
6. outlet bus-bar
7. insulator panel
8. inlet electrical collector ring
9. outlet electrical collector ring
10. inlet shock loading cable
11. exit shock loading cable
12. high-speed inlet section
13. - - -
14. inflection point
15. electron field compaction section
16. compaction termination
17. electron acceleration section
18. Inlet ceramic cylinder flange
19. outlet ceramic cylinder flange
20. screws (shown in 44 places)

What is claimed is:

1. A plurality of short wire segments having a single bend forming a “U” shape electrical element hereinafter termed a filament, a plurality of said filaments being electrically attached in parallel circuit between an inlet bus-bar and an exit bus-bar, said inlet bus-bar, said exit bus-bar fixedly attached to a separating insulating panel, said filaments, said bus-bars and said insulating panel forming an assembly hereinafter called a linear track, a plurality of said linear tracks being longitudinally aligned and radially mounted at evenly spaced circumferential positions about the outer surface of a ceramic cylinder that is flanged at each end, heated carbon dioxide carrier gas mixed with positive charged ions and protons flowing into said ceramic cylinder and actinically radiated by negative charged electron field particle called chards, chard material from said linear tracks, said actinic chard radiation passing through the wall of the ceramic cylinder of said alignment chamber to produce carbon polymers with said heated carbon dioxide carrier gas.

2. claim 1 in which the said heated carrier gas is heated nitrogen.

3. claim 1 in which the electricity to the inlet electrical collector ring is a pulsing high intensity shock load current.

4. A procedure for producing aldehyde (CO₂H) radicals by hydrolyzation of finite quantities of alkaline metals at 1 hz intervals in simultaneous equipoise within a heated CO₂ carrier gas flowing through a hydrolyzation chamber producing periodic intense electrical actinic discharge of electrons and protons forming a diffuse mixture within the heated CO₂ carrier gas passing into a tuyere, electrons in the diffuse mixture electrostatically absorbed on tuyere strakes and electrostatically transferred to a dielectric capacitor circuit and electrically conducted by electrical conduit out of the dielectric capacitor circuit by electrical conduit to wire segment filaments positioned on the outer surfaces of a ceramic cylinder of an alignment chamber to produce an actinic flux field which actinically radiates through the ceramic cylinder wall to produce a negative flux field within the volume of the ceramic cylinder, protons within the mixture flow out of the tuyere into the ceramic cylinder of the alignment chamber and pass through the flux field and deposit electrons to protons (H⁺) between CO₂ molecules of the heated carrier gas to form aldehdes CO₂H.

5. Claim 4 in which the alkaline metal is sodium.

6. Claim 4 in which the alkaline metal is potassium.

7. Claim 4 in which the alkaline metal is a mixture of sodium and potassium.

8. Claim 4 in which the heated carrier gas is nitrogen.

9. Claim 4 in which the periodic intense electrical actinic discharge of electrons and protons is produced as a pulsating coulombic direct current.
